(19) United States
(12) Patent Application Publication
(10) Pub. No.: US 2015/0157019 A1
(43) Pub. Date: Jun. 11, 2015

(54) CRYSTAL OF FLUMIOXAZIN

(71) Applicant: SUMITOMO CHEMICAL COMPANY, LIMITED, Tokyo (JP)

(72) Inventors: Mitsunori Hiratsuka, Niihama-shi (JP); Chizuko Sasaki, Yokohama-shi (JP); Fumiko Murayama, Yokohama-shi (JP)

(73) Assignee: SUMITOMO CHEMICAL COMPANY, LIMITED, Tokyo (JP)

(21) Appl. No.: 14/407,126

(22) PCT Filed: Jun. 7, 2013
(86) PCT No.: PCT/JP2013/066410

§ 371 Date: Dec. 11, 2014

(30) Foreign Application Priority Data
Jun. 14, 2012 (JP) 2012-134889

(51) Int. Cl. A01N 43/84

(52) U.S. Cl. CPC A01N 43/84

(57) ABSTRACT

A crystal of flumioxazin,
which is one selected from the group consisting of 1^{st} crystal, 2^{nd} crystal, 3^{rd} crystal, 4^{th} crystal, 5^{th} crystal, 6^{th} crystal and 7^{th} crystal,
each of the crystals showing a powder X-Ray diffraction pattern which has diffraction peaks with 2θ values (°) shown in the correspoding right column of Table.

| | TABLE |
|---|---|
| | 2θ value (°) |
| 1^{st} crystal | 7.5 ± 0.1, 11.9 ± 0.1, 15.3 ± 0.1 |
| 2^{nd} crystal | 8.7 ± 0.1, 9.4 ± 0.1, 14.7 ± 0.1, |
| | 18.8 ± 0.1 |
| 3^{rd} crystal | 7.7 ± 0.1, 10.9 ± 0.1, 13.5 ± 0.1, |
| | 14.6 ± 0.1, 15.0 ± 0.1 |
| 4^{th} crystal | 7.7 ± 0.1, 10.7 ± 0.1, 13.4 ± 0.1, |
| | 14.3 ± 0.1, 14.8 ± 0.1 |
| 5^{th} crystal | 5.5 ± 0.1, 10.3 ± 0.1, 10.9 ± 0.1, |
| | 13.2 ± 0.1 |
| 6^{th} crystal | 7.7 ± 0.1, 8.6 ± 0.1, 11.0 ± 0.1, |
| | 13.2 ± 0.1, 14.7 ± 0.1, 15.1 ± 0.1, |
| 7^{th} crystal | 14.5 ± 0.1, 18.7 ± 0.1 |

### TECHNICAL FIELD

The present invention relates to a crystal of flumioxazin.

### BACKGROUND ART

Flumioxazin is sold as a herbicide in many countries, including Japan (Sumitomo Chemical 2001-I, p. 14-25, The Pesticide Manual, 13th ed., British Crop Protection Council, p. 461-462 (2003)). Flumioxazin is a yellowish brown powder solid (Sumitomo Chemical 2001-1, p. 14-25). JP 61-76486A1 and JP 5-97848A1 mention a method for producing flumioxazin.

### DISCLOSURE OF THE INVENTION

The present invention includes the followings.
[1] A crystal of flumioxazin,

which is one selected from the group consisting of 1^{st} crystal, 2^{nd} crystal, 3^{rd} crystal, 4^{th} crystal, 5^{th} crystal, 6^{th} crystal and 7^{th} crystal,

each of the crystals showing a powder X-Ray diffraction pattern which has diffraction peaks with 2θ values (°) shown in the corresponding right column of Table 1.

TABLE 1

| | 2θ value (°) |
|---|---|
| 1^{st} crystal | 7.5 ± 0.1, 11.9 ± 0.1, 15.3 ± 0.1 |
| 2^{nd} crystal | 8.7 ± 0.1, 9.4 ± 0.1, 14.7 ± 0.1, 18.8 ± 0.1 |
| 3^{rd} crystal | 7.7 ± 0.1, 10.9 ± 0.1, 13.5 ± 0.1, |
| | 14.6 ± 0.1, 15.0 ± 0.1 |
| 4^{th} crystal | 7.7 ± 0.1, 10.7 ± 0.1, 13.4 ± 0.1, |
| | 14.3 ± 0.1, 14.8 ± 0.1 |
| 5^{th} crystal | 5.5 ± 0.1, 10.3 ± 0.1, 10.9 ± 0.1, |
| | 13.2 ± 0.1 |
| 6^{th} crystal | 7.7 ± 0.1, 8.6 ± 0.1, 11.0 ± 0.1, |
| | 13.2 ± 0.1, 14.7 ± 0.1, 15.1 ± 0.1, |
| 7^{th} crystal | 14.5 ± 0.1, 18.7 ± 0.1 |

[2] The crystal according to [1],

which is an isolated crystal.

[3] A formulation which comprises the crystal according to [1] or [2] as an active ingredient.
[4] A herbicide obtained by formulating the crystal according to [1] or [2] as an active ingredient.
[5] A method for producing a herbicide, which comprises the step of formulating the crystal according to [1] or [2] as an active ingredient to obtain the herbicide.

### MODE FOR CARRYING OUT THE INVENTION

Hereinafter, the present invention will be described in detail.

The crystal of the present invention is one selected from the group consisting of 1^{st} crystal, 2^{nd} crystal, 3^{rd} crystal, 4^{th} crystal, 5^{th} crystal, 6^{th} crystal and 7^{th} crystal.

Each crystal of 1^{st} crystal to 7^{th} crystal shows a powder X-Ray diffraction pattern having diffraction peaks with 2θ values (°) shown in the corresponding right column of the above-mentioned Table.

Herein, the powder X-Ray diffraction pattern can be obtained by the powder X-ray diffraction measurement such as CuKα rays diffraction analysis.

Generally, the substances to be used for herbicides or the like are required. to have high purity. Furthermore, required are to maintain their crystal form during the heating treatment step Cr the like steps for formation, to show physical and chemical properties advantageous on the productions of formulations, and to maintain their properties for long-term storage.

The 1^{st} crystal to 7^{th} crystal of the present invention can be produced by the methods disclosed in Example and modified methods thereof.

The crystals of the present invention can be obtained, for example, by conducting the following steps.

First, a starting material is dissolved in an organic solvent to obtain a solution which contains flumioxazin at the concentration generally in the range of 2 mg to 200 mg, preferably in the range of 5 mg to 120 mg, per ml of the solvent, and setting the temperature of the obtained solution generally within the range of 40° C. to 80° C., preferably within the range of 50° C. to 75° C.

Then, the heated solution may be heated to rapidly volatilizing its solvent, for example by dropping the solutin onto the heated glass plate or the like to form and isolate crystals.

The heated solvent is preferably cooled to its temperature generally from about 0° C. to less than 25° C., preferably from about 10° C. to 25° C. to form a crystal. Preferably the step of cooling the heated solution is gradually conducted, specifically by lowering the solution preferably at 5° C. to 15° C. per hour, more preferably at around 10° C. per hour. Water or other solvent at the same temperature as that of the heated solution can be added to the solution before cooling for easily forming crystals. After cooling the solution, the cooled solution is maintained at the lowered temperature to form a crystal. The time of maintenance for the solution depends on the scale, temperature or other conditions of the solution, which can be arbitrarily determined.

The crystals of the present invention can be collected in a known manner, for example, by filtration, by concentration, by centrifugation or by decantation. The crystal may be washed with an appropriate solvent, if necessary. The crystal may be subjected to the method comprising the above-mentioned steps or slurry filtration for improving its purity or quality.

It is possible to use, as the starting material for producing the crystal of the present invention, a solution or a suspension of flumioxazin, or a mixture containing flumioxazin. It is also possible to use a solution or a suspension of a synthetic reaction crude product containing flumioxazin.

The organic solvent to be used for the crystallization includes alcohols such as methanol, 2-methoxyethanol, 2-ethoxyethanol, ethers such as tetrahydrofuran, acetone, 1,4-dioxane, halogenated hydrocarbons such as chloroform, 1,2-dichloroethane or chlorobenzene, and aromatic hydrocarbons such as xylene or toluene.

It is also possible to use seed crystals in crystallization for producing the crystal of the present invention. In that case, it is preferred to use crystals having a crystal form to be prepared. The amount of seed crystals to be added is preferably from 0.0005 parts by weight to 0.02 parts by weight, and more preferably from 0.001 part by weight to 0.01 part by weight, based on 1 part by weight of flumioxazin.

The crystals of the present invention may be a solvate or a non-solvate.

When a specific hydrophilic organic solvent is used as a crystallization solvent, the obtained crystals are sometimes crystals of a solvate. The crystals of a non-solvate can be obtained by heating to dry the crystals of a solvate under reduced pressure.

The degree of drying of the crystals can be determined by analytical means such as gas chromatography.

It is also possible to determine the purity of the. crystal form of the crystal by subjecting the crystal to the powder X-ray diffraction measurement such as CuKα rays diffraction analysis, followed by analyzing the obtained diffraction pattern about the presence or absence of diffraction peaks peculiar to crystal of a solvate, and the height of the peaks.

The crystal of the present invention can be produced with high purity, can remain unchanged in crystal form even after a heat treating step for formulation, can also exhibit physical and chemical properties which are more advantageous for the production of a formulation, and can maintain such properties even after being stored for a long period.

The crystal of the present invention can be formulated by a method described hereinafter. The formulation which comprises the crystal as an active ingredient is one aspect of the present invention. An herbicide can be obtained⁻ by formulating the crystal of the present invention as an active ingredient. The herbicide which comprises the crystal of the present invention, and a method for producing such herbicide fall within the scope of the present application.

When the formulation is prepared from the crystal of the present invention, the crystal are usually mixed with a solid carrier, a liquid carrier, a surfactant, and other auxiliaries for formulation, and then the mixture is formulated into an emulsifiable concentrate, a wettable powder, a suspension concentrate, or a granule. The formulation of the present invention comprises, as an active ingredient, the crystal of the present invention in the amount of 0.05% to 90%, and preferably 0.1% to 80% by weight of the total amount thereof.

Examples of the solid carrier include fine powders or granules of minerals, such as kaolin clay, attapulgite clay, bentonite, acidic white clay, pyrophylite, talc, diatomaceous earth, calcite, walnut shell flour, urea, ammonium sulfate, and synthetic hydrated silicon oxide. Examples of the liquid carrier include aromatic hydrocarbons such as xylene and methylnaphthalene; alcohols such as isopropanol, ethylene glycol, and cellosolve; ketones such as acetone, cyclohexanone, and isophorone; vegetable oils such as soybean oil and cottonseed. oil; dimethyl sulfoxide, N,N-dimethylformamide, acetonitrile, and water.

Examples of the surfactant to be used for emulsification, dispersion, and wetting include anionic surfactants such as alkylsulfate ester salts, alkylarylsulfonates, dialkylsulfosuccinates, and polyoxyethylenealkylaryletherphosphate ester salts; and nonionic surfactants such as polyoxyethylenealkylethers, polyoxyethylenealkylarylethers, polyoxyethylene polyoxypropylene block copolymers, sorbitan fatty acid esters, and polyoxyethylene sorbitan fatty acid esters. Examples of other auxiliaries for formulation include ligninsulfonates, alginates, polyvinyl alcohol, gum arabic, carboxymethyl cellulose (CMC), and isopropyl acid phosphate (PAP).

The crystal of the present invention can be used, as active ingredients of the herbicide for agricultural lands such as cultivated lands, paddy fields, orchards, grasslands, lawns, and forests, or non-agricultural lands.

The herbicide or formulation of the present invention can be applied to a soil treatment, a foliar treatment, or a flooding treatment before or after the germination of weeds. Examples of the soil treatment include a soil surface treatment and a soil mixing treatment. Examples of the foliar treatment include, in addition to a treatment by application from above plants, and a local treatment in which only weeds are treated so as not to apply the herbicide to crops.

Further improvement in the herbicidal effect can be expected by using the herbicide in combination with other herbicides. It is also possible to use it in combination with insecticides, acaricides, nematocides, fungicides, plant growth regulators, fertilizers, and soil conditioners.

When the crystals of the present invention are used as active ingredients of the herbicide, the amount thereof varies depending on the weather conditions, type of the formulation, timing of the treatment, method, place, weed to be killed and crop to be obtained and is usually from 0.02 g to 100 g, and preferably from 0.05 g to 50 g, per are of the land, i.e. per 100 m² of the land to be treated. A predetermined amount of the emulsion concentrate, wettable powder or suspension concentrate is usually diluted with 1 to 10 liters, per are, of water containing, if necessary, an auxiliary such as a spreader before the treatment. The granule is usually used directly without dilution.

Examples of the spreader include, in addition to the above-mentioned surfactants, polyoxyethylene resin acids (esters), ligninsulfonates, abietates, dinaphthylmethanedisulfonates, and paraffin.

### EXAMPLES

The present invention will be described in more detail below by way of Examples.

The powder X-ray diffraction patterns of the obtained crystals were measured by X'Pert Pro MPD (manufactured by PANalytical B.V., Netherland) at a scanning range from 2.0° to 40.0° (2θ) using Cukα rays (40 kV, 30 mA).

### Example 1

Flumioxazin (100 mg) was dissolved in 2-methoxyethanol at 60° C. so as to adjust its concentration to 16.8 mg/mL. Then 10 times volumes of water relative to the volume of 2-methoxyethanol were heated to 60° C. and gradually added to the obtained solution. The obtained mixture was gradually cooled to 20° C. at the rate of 10° C. per hour and then left to stand, followed by filtrating it to collect crystals.

The pattern of the obtained crystals had the peaks with 2θ values as shown in Table 2 to find them 1^{st} crystals.

TABLE 2

| 2θ value (°) | d value (Å) | Relative intensity (%) |
|---|---|---|
| 7.5 | 11.7774 | 22.5 |
| 11.9 | 7.4308 | 61.9 |
| 15.3 | 5.8241 | 11.0 |

The 1^{st} crystals were obtained by the same method as mentioned above except that methanol or 2-ethoxyethanol was used instead of 2-methoxyethanol.

### Example 2

Flumioxazin (100 mg) was dissolved in tetrahydrofuran [THF] at 60° C. so as to adjust its concentration to 51.0 mg/mL. The obtained mixture was gradually dropped onto a glass plate heated at 100° C. to rapidly volatilize its solvent therefrom, to obtain crystals.

The pattern of the obtained crystals had the peaks with 2θ values as shown in Table 3 to find them 2^{nd} crystals.

TABLE 3

| 2θ value (°) | d value (Å) | Relative intensity (%) |
|---|---|---|
| 8.7 | 10.1555 | 20.4 |
| 9.4 | 9.4007 | 43.5 |
| 14.7 | 6.0211 | 62.0 |
| 18.8 | 4.7162 | 100.0 |

The 2^{nd} crystals were obtained by the same method as mentioned above except that acetone was used instead of THF. The crystals were obtained by adding methanol instead of THF to flumioxazin, gradually cooling to 20° C., followed by leaving it to stand.

### Example 3

Flumioxazin (100 mg) was dissolved in 1,2-dichloroethane at 60° C. so as to adjust its concentration to 50.9 mg/mL. Then the obtained solution was gradually cooled to 20° C. at the rate of 10° C. per hour and then left to stand, followed by blow its solvent with nitrogen gas to obtain crystals.

The pattern of the obtained crystals had the peaks with 2θ values as shown in Table 4 to find them 3^{rd} crystals.

TABLE 4

| 2θ value (°) | d value (Å) | Relative intensity (%) |
|---|---|---|
| 7.7 | 11.4720 | 100.0 |
| 10.9 | 8.1102 | 21.5 |
| 13.5 | 6.5535 | 41.1 |
| 14.6 | 6.0621 | 9.5 |
| 15.0 | 5.9013 | 12.6 |

The 3^{rd} crystals were obtained. by the same method as mentioned above except that chlorobenzene was used instead of 1,2-dichloroethane.

### Example 4

Flumioxazin (100 mg) was dissolved in toluene at 60° C. so as to adjust its concentration to 13.3 mg/mL. Then the obtained solution was gradually cooled to 20° C. at the rate of 10° C. per hour and then left to stand, followed by blow its solvent with nitrogen gas to obtain crystals.

The pattern of the obtained crystals had the peaks with 2θ values as shown in Table 5 to find them 4^{th} crystals.

TABLE 5

| 2θ value (°) | d value (Å) | Relative intensity (%) |
|---|---|---|
| 7.7 | 5.9013 | 100.0 |
| 10.7 | 8.2613 | 13.9 |
| 13.4 | 6.6022 | 25.5 |
| 14.3 | 6.1886 | 4.6 |
| 14.8 | 5.9806 | 6.8 |

### Example 5

Flumioxazin (100 mg) was dissolved in xylene at 60° C. so as to adjust its concentration to 10.0 mg/mL. Then the obtained solution was gradually cooled to 20° C. at the rate of 10° C. per hour and then left to stand, followed by blow its solvent with nitrogen gas at 20° C. to obtain crystals.

The pattern of the obtained crystals had the peaks with 2θ values as shown in Table 6 to find them 5^{th} crystals.

TABLE 6

| 2θ value (°) | d value (Å) | Relative intensity (%) |
|---|---|---|
| 5.5 | 16.0548 | 23.1 |
| 10.3 | 8.5812 | 68.2 |
| 10.9 | 8.1102 | 29.7 |
| 13.2 | 6.7018 | 37.6 |

### Example 6

Flumioxazin (100 mg) was dissolved in chloroform at 60° C. so as to adjust its concentration to 102.8 mg/mL. The chloroform solution was added gradually to 10 times volumes of heptane relative to the volume of chloroform at 60° C. The obtained mixture was gradually cooled to 20° C. at the rate of 10° C. per hour and then left to stand, followed by filtrating it to collect crystals.

The pattern of the obtained crystals had the peaks with 2θ values as shown in Table 7 to find them 6^{th} crystals.

TABLE 7

| 2θ value (°) | d value (Å) | Relative intensity (%) |
|---|---|---|
| 7.7 | 11.4720 | 100.0 |
| 8.6 | 10.2733 | 5.8 |
| 11.0 | 8.0367 | 14.4 |
| 13.2 | 6.7018 | 6.7 |
| 14.7 | 6.0211 | 7.4 |
| 15.1 | 5.8625 | 9.2 |

The 6^{th} crystals were obtained by the same method as mentioned above except that THF was used instead of chloroform:
The solution obtained by adding 2 times volumes of THF relative to the volume of chloroform to flumioxazin instead of chloroform, was added to 10 times volumes of water relative to the volume of THF and gradually cooled to 20° C., followed by leaving it to stand.
The crystals were obtained by adding THF, 1,4-dioxane or pyridine instead of chloroform to flumioxazin and, gradually cooling to 20° C., followed by concentrating it.

### Example 7

Flumioxazin (100 mg) was dissolved in 1,4-dioxane at 60° C. so as to adjust its concentration to 50.9 mg/mL. The 1,4-dioxane solution was added gradually to 10 times volumes of water relative to the volume of 1,4-dioxane at 60° C. The obtained mixture was gradually cooled to 20° C. at the rate of 10° C. per hour and then left to stand, followed by filtrating it to collect crystals.

The pattern of the obtained crystals had the peaks with 2θ values as shown in Table 8 to find them 7^{th} crystals.

TABLE 8

| 2θ value (°) | d value (Å) | Relative intensity (%) |
|---|---|---|
| 14.5 | 6.1037 | 15.6 |
| 18.7 | 4.7412 | 36.4 |

The 7^{th} crystals were obtained by the same method as mentioned above except that heptane was used instead of water.

### Formulation Example 1

Fifty (50) parts of the crystals of the present invention, 8 parts of calcium ligninsulfoate, 2 parts of sodium lauryl sulfate, and 45 parts of synthetic hydrated silicon oxide are well ground and mixed to obtain wettable powders.

### Formulation Example 2

Five (5) parts of the crystals of the present invention, 14 parts of polyoxyethylene styryl phenyl ether, 6 parts of calcium dodecylbenzene sulfonate, 80 parts of xylene, and 45 parts of isophorone are well mixed to obtain emulsifiable concentrates.

### Formulation Example 3

Two (2) parts of the crystals of the present invention, 1 part of synthetic hydrated silicon oxide, 2 parts of calcium ligninsulfoate, 30 parts of bentonite, and 65 parts of kaolin clay are well ground and mixed. After adding water, the mixture is well kneaded, and then the kneaded mixture is granulated and dried to obtain granules.

### Formulation Example 4

Twenty-five (25) parts of the crystals of the present invention, 8 parts of polyoxyethylene sorbitan monoleate, 8 parts of CMC, and 69 parts of water are mixed, and then the mixture is wet-ground until the particle size becomes 5 microns or less to obtain suspension concentrates.

### Formulation Example 5

Five (5) parts of the crystals of the present invention, 14 parts of polyoxyethylene styryl phenyl ether, 6 parts of calcium dodecylbenzene sulfonate, 80 parts of xylene, and 45 parts of N,N-dimethylformamide are well mixed to obtain emulsifiable concentrates.

### INDUSTRIAL APPLICABILITY

According to the present invention, crystals of flumioxazin having excellent physical and chemical properties can be provided.

1. A crystal of flumioxazin,
which is one selected from the group consisting of 1^{st} crystal, 2^{nd} crystal, 3^{rd} crystal, 4^{th} crystal, 5^{th} crystal, 6^{th} crystal and 7^{th} crystal,
each of the crystals showing a powder X-Ray diffraction pattern which has diffraction peaks with 2θ values (°) shown in the corresponding right column of Table:

| | TABLE |
|---|---|
| | 2θ value (°) |
| 1^{st} crystal | 7.5 ± 0.1, 11.9 ± 0.1, 15.3 ± 0.1 |
| 2^{nd} crystal | 8.7 ± 0.1, 9.4 ± 0.1, 14.7 ± 0.1, |
| | 18.8 ± 0.1 |
| 3^{rd} crystal | 7.7 ± 0.1, 10.9 ± 0.1, 13.5 ± 0.1, |
| | 14.6 ± 0.1, 15.0 ± 0.1 |
| 4^{th} crystal | 7.7 ± 0.1, 10.7 ± 0.1, 13.4 ± 0.1, |
| | 14.3 ± 0.1, 14.8 ± 0.1 |
| 5^{th} crystal | 5.5 ± 0.1, 10.3 ± 0.1, 10.9 ± 0.1, |
| | 13.2 ± 0.1 |
| 6^{th} crystal | 7.7 ± 0.1, 8.6 ± 0.1, 11.0 ± 0.1, |
| | 13.2 ± 0.1, 14.7 ± 0.1, 15.1 ± 0.1, |
| 7^{th} crystal | 14.5 ± 0.1, 18.7 ± 0.1 |

2. The crystal according to claim 1,
which is an isolated crystal.

3. A formulation which comprises the crystal according to claim 1 as an active ingredient.

4. A herbicide obtained by formulating the crystal according to according to claim 1 as an active ingredient.

5. A method for producing an herbicide, which comprises the step of formulating the crystal according to claim 1 as an active ingredient to obtain the herbicide.
